(19) United States
(12) Patent Application Publication
(10) Pub. No.: US 2008/0006330 A1
(43) Pub. Date: Jan. 10, 2008

(54) A Throttle Mechanism

(76) Inventor: Huasong ZHOU, Xiamen (CN)

Correspondence Address: Dr. BANGER SHIA, 102 Lindencrest Ct, Sugar Land, TX, 77479-5201, US

(21) Appl. No.: 11/428,702

(22) Filed: Jul. 5, 2006

(51) Int. Cl. F16K 17/30

(52) U.S. Cl. 137/498

(57) ABSTRACT

The present invention provides a throttle mechanism typically comprised of a nut, an orifice sleeve, a pressure spring and main body; wherein said nut and said orifice sleeve are possessed of an inlet individually at the top end, the diameter of the inlet of the orifice sleeve is smaller than the nut's, said both inlets construct to the intake pathway. The bottom rim of the orifice sleeve and an inner platform of the main body construct a ring outlet with the circular gap. Due to the structure including a nut, an orifice sleeve, and so on, the present invention has fewer numbers of parts, and simple structure features. By means of the different water pressure exerting on the orifice sleeve in the pipeline, the orifice area of discharging is changed so that the out-flowing water is kept in stable and consistent, the operation of it is smooth and reliable, by means of the preloading spring, the restriction flow can be controlled accurately and smoothly.

### BACKGROUND OF THE INVENTION

1. Field of the Invention

The present invention relates to a flow restriction control chock, and more particularly to a water throttle mechanism.

2. Description of Prior Art

For preventing water from turbulent flowing occurred by fluctuating water pressure in the pipeline, and keeping water flowing smoothly and stably, consistently, to locate a throttle gear in the pipe is carried out.

### OBJECTS AND SUMMARY OF THE INVENTION

It is therefore a main object of the present invention to provide a throttle mechanism with simple structure, efficiently flowing restriction control and convenient mounting and use features.

For achieving the above-mentioned object, the present invention provides a throttle mechanism is typically of a nut, an orifice sleeve, a pressure spring and main body; wherein said nut and said orifice sleeve are possessed of an inlet individually at the top end, the diameter of the inlet of the orifice sleeve is smaller than the nut's, said both inlets construct to the intake pathway; said nut is secured on the top portion of the main body, and said orifice sleeve is placed in the cavity of the main body; the bottom rim of the orifice sleeve and an inner platform of the main body construct a ring outlet with the circular gap; said pressure spring is located under said orifice sleeve and standing on the inner platform of the main body.

Said main body is a hollow cylinder with an open upper portion with a male thread formed on the outside wall at the top end, and an inner platform formed on the bottom side of the cavity at the low portion; said nut is secured on the male thread of the main body.

Said orifice sleeve is in tube shaped with an open bottom end and an inlet formed on the top closed end, and placed into the cavity of the main body, and the external diameter coordinates to the inner platform of the main body's.

The external diameter of said orifice sleeve is as same as the inner platform of the main body's.

Said pressure spring is covered at the hollow inside of said orifice sleeve, the top end touches against the inside of the inlet of the orifice sleeve, and another end stands on the top surface of the inner platform of the main body; said orifice sleeve is pushed to touch against the inside surface of the nut by the pressure spring.

The present invention also includes an O-ring putting on the outside wall of the main body.

As utilizing above-mentioned project, due to the structure including a nut, an orifice sleeve, a pressure spring and a main body, the present invention has fewer numbers of parts, and simple structure features. In practice, the present invention can be located in any position at inside the pipeline facilitating to installation and use. By means of the different water pressure exerting on the orifice sleeve in the pipeline, the orifice area of discharging is changed so that the out-flowing water is kept in stable and consistent, the operation of it is smooth and reliable, by means of the preloading spring, the restriction flow can be controlled accurately and smoothly.

### BRIEF DESCRIPTION OF THE DRAWINGS

FIG. 1 is a cross-section view showing the less flow state of the present invention.

FIG. 2 is a cross-section view showing the orifice state of present invention.

FIG. 3 is a cross-section view showing the use state of the present invention.

### DETAILED DESCRIPTION OF PREFERRED EMBODIMENTS

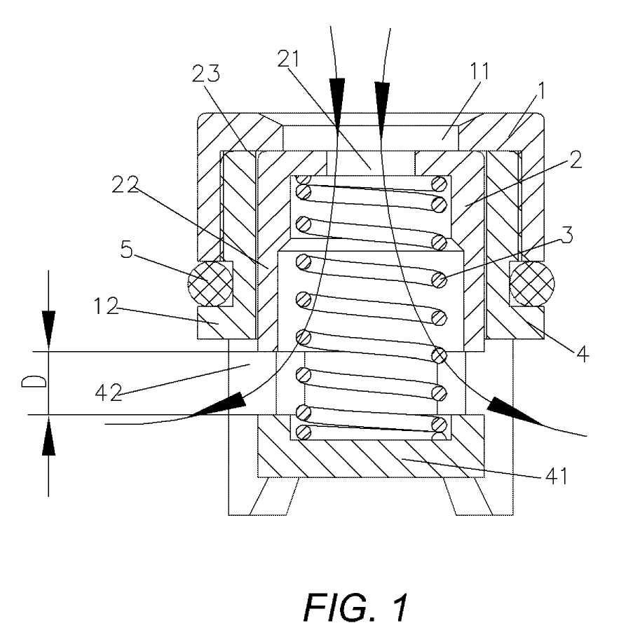

Referring to FIG. 1, a throttle mechanism discovered by the present invention is typically comprised of a nut 1, an orifice sleeve 2, a pressure spring 3, a main body 4 and an O-ring 5.

Wherein, said main body 4 is a hollow cylinder with an open upper portion with a male thread formed on the outside wall at the top end, and an inner platform 41 formed on the bottom side of the cavity at the low portion.

Said nut 1 is secured on the male thread of the main body 4, and is possessed of an inlet 11 formed on the top end surface.

Said orifice sleeve 2 is in tube shaped, and contained in the cavity of the main body 4 in up-down moving fit. Said orifice sleeve 2 is possessed of an open bottom end and an inlet 21 formed on the top closed end. The inlet 21 of said orifice sleeve 2 and the inlet 11 of the nut 1 construct to the intake pathway; the diameter of the inlet 11 of the nut 1 is bigger than the inlet 21 of the orifice sleeve 2's, facilitating to generate pressure exerting on the orifice sleeve 2. The external diameter of the orifice sleeve 2 is as same as the inner platform 41 of the main body 4's, the bottom rim of the orifice sleeve 2 and an inner platform 41 of the main body 4 construct a ring outlet with the circular gap 42.

Said pressure spring 3 is covered at the hollow inside cavity 22 of said orifice sleeve 2, the top end touches against the inside 23 of the inlet 21 of the orifice sleeve 2, and another end stands on the top surface of the inner platform 41 of the main body 4 so that the top surface of said orifice sleeve 2 is pushed to touch against the inside surface 23 of the nut 2 by the pressure spring 3.

Said O-ring 5 is located in a ring groove 12 formed on the outside wall of the main body 1.

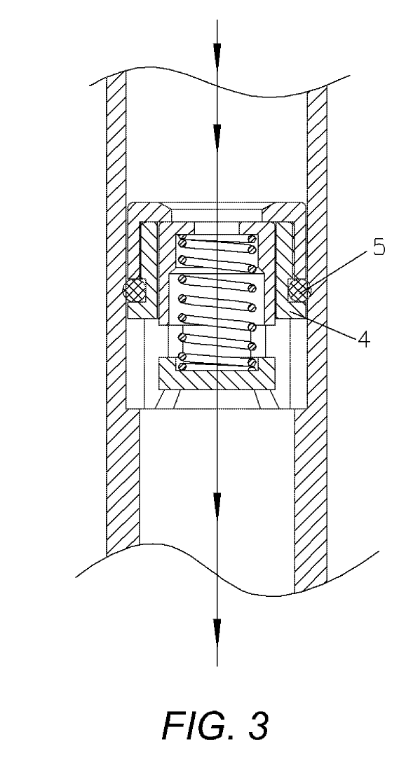

Referring to FIG. 3, the present invention can be placed on any position of the pipeline.

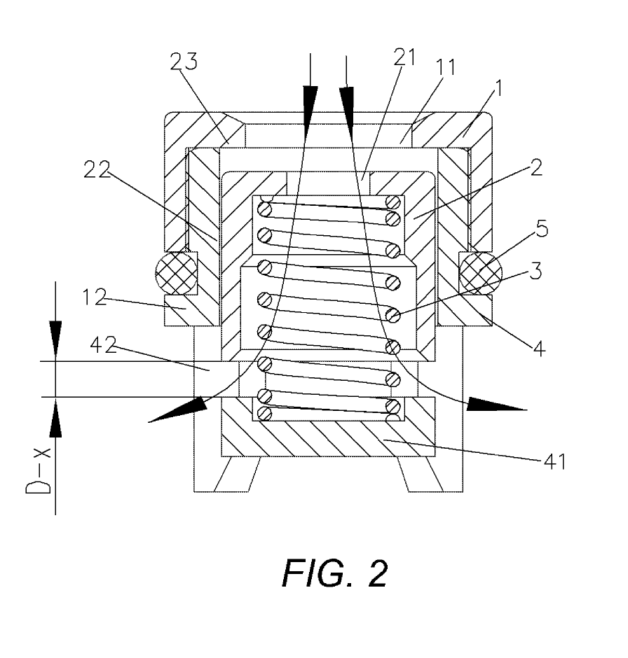

The working principle of the present invention is that, when water flows through the both inlets 11 21 of said nut 1 and said orifice sleeve 2, to generate the different pressure at the both sides of orifice sleeve 2. When the different pressure is bigger than the presetting pushing force of the pressure spring 3 (as shown in FIG. 2), the orifice sleeve 2 is pushed down by the water different pressure moving distance X, the out-flowing gap 42 between the bottom rim of the orifice sleeve 2 and top surface of the inner platform 41 of the main body 1 is reduced to D-X, so the output flow is decreased; whereas, when the output flow is less, the different pressure is less than the pushing force of the spring 3, the orifice sleeve 2 is pushed up by the pressure spring 3 until touching against the inside surface of the orifice sleeve 2, further to restore the ring output gap 42 to the distance D (as shown in FIG. 1), so the output flow is increased again. Therefore, the smooth flowing is carried out.

I claim:

1. A throttle mechanism typically comprised of a nut, an orifice sleeve, a pressure spring and main body; wherein said nut and said orifice sleeve are possessed of an inlet individually at the top end, the diameter of the inlet of the orifice sleeve is smaller than the nut's, said both inlets construct to the intake pathway; said nut is secured on the top portion of the main body, and said orifice sleeve is placed in the cavity of the main body; the bottom rim of the orifice sleeve and an inner platform of the main body construct a ring outlet with the circular gap; said pressure spring is located under said orifice sleeve and standing on the inner platform of the main body.

2. A throttle mechanism as claimed in claim 1, wherein said main body is a hollow cylinder with an open upper portion with a male thread formed on the outside wall at the top end, and an inner platform formed on the bottom side of the cavity at the low portion; said nut is secured on the male thread of the main body.

3. A throttle mechanism as claimed in claim 1, wherein said orifice sleeve is in tube shaped with an open bottom end and an inlet formed on the top closed end, and placed into the cavity of the main body, and the external diameter coordinates to the inner platform of the main body's.

4. A throttle mechanism as claimed in claim 1, wherein the external diameter of said orifice sleeve is as same as the inner platform of the main body's.

5. A throttle mechanism as claimed in claim 1, wherein said pressure spring is covered at the hollow inside of said orifice sleeve, the top end touches against the inside of the inlet of the orifice sleeve, and another end stands on the top surface of the inner platform of the main body; said orifice sleeve is pushed to touch against the inside surface of the nut by the pressure spring.

6. A throttle mechanism as claimed in claim 1, wherein an O-ring included is put on the outside wall of the main body.
